(19) United States
(12) Patent Application Publication
(10) Pub. No.: US 2015/0175045 A1
(43) Pub. Date: Jun. 25, 2015

(54) MOTOR VEHICLE SEAT ELEMENT

(71) Applicant: GM GLOBAL TECHNOLOGY OPERATIONS LLC, Detroit, MI (US)

(72) Inventors: Christian Kuhley, Gross-Gerau (DE); Juergen Maier, Weitersweiler (DE)

(21) Appl. No.: 14/573,788

(22) Filed: Dec. 17, 2014

(30) Foreign Application Priority Data
Dec. 19, 2013 (DE) 102013021692.3

(51) Int. Cl. B60N 2/68; B21B 1/38; B21J 5/00; B21D 5/00; B21D 22/20

(52) U.S. Cl. CPC B60N 2/686; B60N 2/68; B21D 5/00; B21D 22/20; B21J 5/00; B21B 1/38

(57) ABSTRACT

A motor vehicle seat element is disclosed having a first sheet element with which a truss structure is positively and/or materially joined. The truss structure is positively and/or materially joined with at least one of an outwardly accessible, separately manufactured functional element and a second sheet element.

### CROSS REFERENCE TO RELATED APPLICATION

This application claims priority to German Patent Application No. 102013021692.3 filed Dec. 19, 2013, which is incorporated herein by reference in its entirety.

### TECHNICAL FIELD

The technical field relates to a motor vehicle seat element, a motor vehicle seat with such a motor vehicle seat element, as well as to a method for manufacturing such a motor vehicle seat element.

### BACKGROUND

Known from DE 10 2010 018 603 A1 is a motor vehicle seat structure with an injection-molded magnesium frame element, whose manufacture yields a functional element, for example a receiving element. The frame element can be formed, for example by semi-solid metal casting.

### SUMMARY

In accordance with one aspect of the present disclosure, a motor vehicle seat element is provided that includes a first sheet element, with which a truss structure is positively and/or materially joined. The truss structure is positively and/or materially joined with one or more outwardly accessible, separately manufactured functional elements.

In an embodiment, the functionality, strength, rigidity and/or service life of the functional elements can be improved in comparison to manufacturing a frame element with integrally designed functional elements via the incorporation of separately manufactured functional elements.

In another aspect of the present disclosure that can be combined with the aforementioned aspect, a motor vehicle seat element includes a first sheet element, which is positively and/or materially joined with a truss structure. The truss structure is positively and/or materially joined with one or more second sheet elements.

In an embodiment, attaching at least one second sheet element advantageously makes it possible to manufacture an overall sheet element with a complex structure and/or with a low weight-rigidity ratio in comparison to a frame element with a one-piece design.

In an embodiment, both aspects share in common the dual function assumed by the truss structure, in that it reinforces the first and, if present, one or more second sheet elements on the one hand, and at the same time joins the first sheet element with the functional element(s) or second sheet elements. As a consequence, the truss structure acts in equal measure as a reinforcement and connection.

In an embodiment, the first and/or one or more second sheet elements exhibit a metal material, in particular steel. In a further development, the first and/or one or more second sheet elements are manufactured out of a metal material, in particular steel, via shaping, in particular via rolling, bending, deep drawing, compression molding or the like. Steel is particularly well suited for such sheet elements from the standpoint of strength and shaping.

In an embodiment, the truss structure exhibits a light metal material, in particular aluminum and/or magnesium. In a further development, the truss structure is manufactured via shaping out of a light metal material, in particular an aluminum and/or magnesium alloy, in particular via casting, in particular injection molding. Light metal materials are especially well suited as a material for truss structures from the standpoint of strength and shaping.

In an embodiment, the truss structure and one or more functional elements exhibit different materials. In a further development, the truss structure and one or more functional elements are manufactured out of different materials. In this way, the truss structure and functional element(s) can be optimally tailored to their respective function in an embodiment, for example the truss structure with respect to rigidity, and a functional element with respect to wear resistance or the like.

In an embodiment, the first and/or one or more second sheet elements exhibit a maximum wall thickness of at most 7 mm, in particular of at most 5 mm, preferably of at most 3 mm. In an embodiment, this makes it possible to achieve a low overall weight together with the truss structure given a sufficient strength and/or rigidity.

In an embodiment, the first and/or one or more second sheet elements exhibit an in particular at least regionally flat and/or graduated wall, with an especially channel-like recess in which the truss structure is arranged. A maximum outer dimension of the wall measures at least twice a maximum channel width in a further development. In an embodiment, this makes it possible to provide a light and rigid wall structure for a motor vehicle seat, in particular a rear bench seat backrest, and/or to advantageously support and/or accommodate the truss structure.

In an embodiment, the truss structure exhibits at least two ribs, which each are positively and/or materially joined with two or three walls angled against each other of the first and/or one or more second sheet elements, in particular with two walls angled against each other in the form of an L or V, or three walls angled against each other in the form of a U. In a further development, two or more such ribs intersect each other. Additionally or alternatively, one or more such ribs can each exhibit varying wall thicknesses over their length. Additionally or alternatively, two or more such ribs can exhibit varying wall thicknesses amongst each other, in particular in pairs. Therefore, in particular the wall thickness of at least one rib can vary and/or at least two different ribs can exhibit varying, in particular maximum, minimum or average, wall thicknesses. In an embodiment, the truss structure can thus be optimally tailored to the loads it is meant to handle. In general, a truss structure is understood in particular as a structure with several webs, especially ribs, which are provided or set up to absorb and relay loads.

In an embodiment, one or more functional elements are sleeves, in particular for accommodating a bolt engaging therein, a screw engaging therein, or the like. Additionally or alternatively, one or more functional elements can be bolts or straps, which in a further development can project out of the motor vehicle seat, in particular as belt deflecting straps or the like. Additionally or alternatively, one or more functional elements can be fittings, in particular for seat adjusters or recliners, which in a further development can project from the motor vehicle seat.

In an aspect of the present disclosure, a motor vehicle seat element described here is arranged in a backrest of a motor vehicle seat, in particular a front or rear seat or a front or rear seat bench. In an embodiment, this makes it possible to advantageously manufacture and/or design the backrest exposed to an especially high load, in particular to have it exhibit second sheet elements secured via the truss structure at a low weight and high rigidity and/or separately manufactured functional elements.

In an aspect of the present disclosure, the first sheet element is arranged in a mold, and in a further development fixed thereto, in particular therein, especially positively and/or frictionally and/or magnetically. Before, during or after, the functional element(s) and/or second sheet elements are arranged in the mold, and in a further development fixed thereto, in particular therein, especially positively and/or frictionally and/or magnetically.

The truss structure is thereafter shaped in the mold, in particular cast, preferably injection molded, and thereby at the same time positively and/or materially joined with the first sheet element and the functional element(s) and/or second sheet element.

### BRIEF DESCRIPTION OF THE DRAWINGS

The present disclosure will hereinafter be described in conjunction with the following drawing figures, wherein like numerals denote like elements.

FIG. 1 is a motor vehicle seat element of a backrest of a front seat according to an embodiment of the present disclosure; and

FIG. 2 is a motor vehicle seat element of a backrest of a rear seat back according to another embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

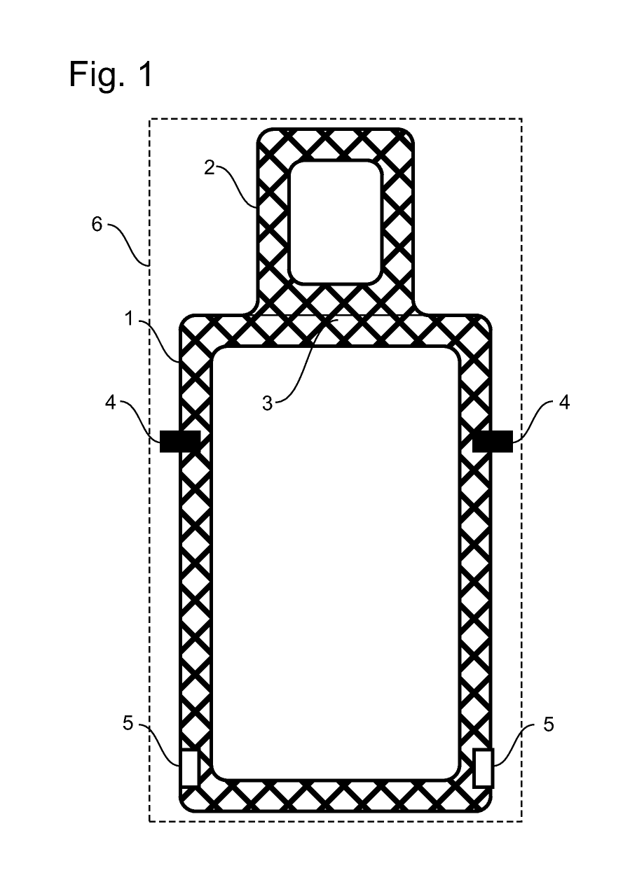

FIG. 1 shows a motor vehicle seat element forming a backrest of a front seat according to an embodiment of the present disclosure. The motor vehicle seat element exhibits a first steel sheet element in the form of a frame 1 with a U-shaped cross section as well as a second steel sheet element in the form of a head section 2, which are joined together.

An upper leg having U-shaped cross section shown in FIG. 1 of the frame 1 is cut out in a central area. In like manner, a lower leg of the U-shaped cross section shown in FIG. 1 of the head section 2 is cut out in a corresponding central area, so that the interior spaces formed by the U-shaped cross sections of the frame 1 and the head section 2 joined thereto communicate with each other.

A truss structure 3 made out of an aluminum and/or magnesium alloy is arranged in these cross sections, and thereby joined positively with both the frame 1 and the head section 2. As a result, the truss structure 3 reinforces the frame 1 and head section 2, and at the same time joins them together.

The truss structure 3 is also positively joined with outwardly accessible, separately manufactured functional elements in the form of two bolts 4 and two fitting elements 5 for a recliner assembly made out of steel or plastic. As a result, the truss structure 3 reinforces the frame 1 and head section 2, and at the same time secures the functional elements 4, 5.

The truss structure 3 exhibits several ribs, which each are positively joined with the three walls angled against each other of the U-shaped cross sections of the frame 1 and head section 2, and intersect each other. They can exhibit varying wall thicknesses (not shown).

In a first embodiment, the motor vehicle seat element is manufactured by initially arranging the first sheet element in the form of the frame 1, the second sheet element in the form of the head section 2, and the functional elements 4, 5 in a mold 6 denoted by dashed lines on FIG. 1.

The truss structure 3 is then manufactured in the mold via casting, and thereby at the same time positively joined with the first sheet element 1, the second sheet element 2 and the functional elements 4, 5.

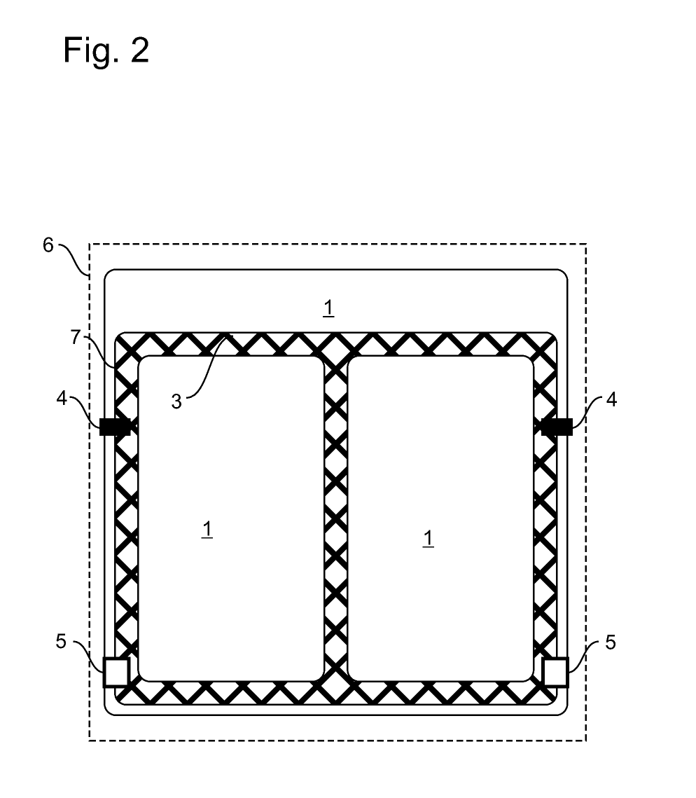

FIG. 2 shows a motor vehicle seat element of a backrest of a rear seat bench according to another embodiment of the present disclosure. Elements corresponding to the above configuration are marked with the same reference numbers, so that reference will be made to their description, and only differences will be discussed below.

In the embodiment on FIG. 2, the motor vehicle seat element exhibits only a first sheet element 1 without a second sheet element. The first sheet element 1 exhibits a regionally flat wall with a channel-like recess 7, in which the truss structure 3 is positively arranged.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-11. (canceled)

12. A motor vehicle seat element comprising a first sheet element fixedly joined to a truss structure, and at least one of an outwardly accessible, separately manufactured functional element or a second sheet element fixedly joined to the truss structure.

13. The motor vehicle seat element according to claim 12, wherein at least one sheet element comprises a metal material manufactured via shaping.

14. The motor vehicle seat element according to claim 12, wherein the truss structure comprises a light metal material manufactured via shaping.

15. The motor vehicle seat element according to claim 12, wherein at least one of the functional element and the truss structure exhibit different materials than the first sheet element.

16. The motor vehicle seat element according to claim 12, wherein at least one sheet element comprises an element having a maximum wall thickness less than or equal to 7 mm

17. The motor vehicle seat element according to claim 16, wherein at least one sheet element comprises an element having a maximum wall thickness less than or equal to 5 mm.

18. The motor vehicle seat element according to claim 17, wherein at least one sheet element comprises an element having a maximum wall thickness less than or equal to 3 mm.

19. The motor vehicle seat element according to claim 12, wherein at least one sheet element comprises an element having a regionally flat wall with a channel-like recess in which the truss structure is arranged.

20. The motor vehicle seat element according to claim 12, wherein at least one sheet element comprises an element having a graduated wall with a channel-like recess in which the truss structure is arranged.

21. The motor vehicle seat element according to claim 12, wherein the truss structure comprises a plurality of ribs, wherein each rib is fixedly joined with at least two walls formed in the at least one sheet element and intersect the other rib.

22. The motor vehicle seat element according to claim 12, wherein the truss structure comprises a plurality of ribs, wherein each rib is fixedly joined with at least two walls formed in the at least one sheet element and exhibit varying wall thicknesses.

23. The motor vehicle seat element according to claim 12, wherein the at least one functional element is selected from the group comprising: a sleeve, a fitting, a bolt or a strap.

24. A motor vehicle comprising a motor vehicle seat element according to claim 12 arranged in a backrest of the motor vehicle seat.

25. A method for manufacturing a motor vehicle seat element according to claim 12 comprising:
arranging the first sheet element in a mold;
arranging at least one of the functional element and the at least one second sheet element in the mold; and
shaping the truss structure in the mold such that the truss structure is fixedly joined with the first sheet element and the at least one functional element or second sheet element at the same time.
